(19) United States
(12) Patent Application Publication
(10) Pub. No.: US 2003/0023589 A1
(43) Pub. Date: Jan. 30, 2003

(54) Method and apparatus for increasing on-line publication distribution

(76) Inventor: Daniel C. Castle, Monmouth, OR (US)

Correspondence Address: HEWLETT-PACKARD COMPANY, Intellectual Property Administration, P.O. Box 272400, Fort Collins, CO, 80527-2400, US

(21) Appl. No.: 09/916,942

(22) Filed: Jul. 26, 2001

(51) Int. Cl. G06F 17/30; G06F 17/60; G06F 7/00

(52) U.S. Cl. 707/5; 705/14

(57) ABSTRACT

Targeting advertisements for such publications to existing subscribers of related on-line publications can increase circulation of the advertised on-line publication. A determination that an individual already subscribes to several publications or often downloads one or more publications is indicative that such a person might not be inclined to receive more publications. Revenue generating ads are sent to such subscribers instead.

### FIELD OF THE INVENTION

This invention relates to the printing field. More particularly, this invention relates to a method and apparatus for improving circulation rates of publications that are delivered through on-line delivery systems.

### BACKGROUND OF THE INVENTION

The Internet and its instantaneous ubiquitous communications has provided to many old and established businesses, revolutionary new ways of either conducting business or improving business and service. For instance, virtually any kind of consumer item can now be obtained via the Internet (i.e., “on-line”). Printing and publishing businesses (e.g., books, treatises, journals) and print media businesses (including but not limited to: newspapers, magazines and periodicals) have also been affected by the Internet and many newspapers, periodicals and books are now available on-line. Among other publishers, the Hewlett-Packard Company offers it's HP Instant Delivery Service (HPID), that is an on-line publication provided via the Internet either by requests generated by the user's computer (pull) or via so-called electronic mail or “email” (push) which includes news and information from a variety of different sources. The HP Instant Delivery service provides a publication to anyone with Internet access that can be printed by a subscriber onto a local printer. HPID and other Internet publications can be customized to provide stories of interest to a subscriber. Because each copy of an Internet publication might have different contents, increasing a publisher's distribution (as opposed to increasing the distribution of a particular publication) is important in Internet publishing.

While the Internet has spawned new opportunities and new ways of conducting even well established business like publishing, many problems that were encountered by businesses in the pre-Internet era are being encountered again in the Internet age. In on-line publishing, as in pre-Internet printed publishing, generating advertising revenue remains a top priority. Because the advertising revenue that a publisher can generate is usually proportional to the number of subscribers that it can demonstrate to prospective advertisers, increasing circulation (i.e., increasing the number of subscribers to publications of the publisher) remains a top priority for on-line publication as it does for printed publications. A method and apparatus by which potential (i.e. new) subscribers can be targeted for advertising of on-line publication subscriptions and additionally targeted for paid advertisements, might improve circulation for on-line publishers and thereby provide enhanced advertising revenue. Such a method and apparatus would find application to conventional publications and publishers as well.

### SUMMARY OF THE INVENTION

There is provided herein a method and apparatus for targeting the delivery of advertisements for publications to potential subscribers and targeting the delivery of revenue-generating advertisements to existing subscribers. Data in a user profile, which is one or more data files that store historical data on an existing subscriber's usage of an on-line publication, is used to help identify whether a particular subscriber to an existing publication would be a good recipient for an advertisement for a related publication. The user profile data is also used to determine whether the subscriber might be a good recipient of paid, revenue-generating advertising. .

### BRIEF DESCRIPTION OF THE DRAWINGS

FIG. 1 shows a depiction of a data network based document distribution system.

FIG. 2 shows an exemplar of a data structure for storing a user profile.

FIG. 3 shows a series of steps performed in a preferred embodiment to selectively target an on-line publication subscriber for delivery of advertising of other publications or for delivery of paid, revenue generating advertising.

FIG. 4 shows a series of steps performed in a preferred embodiment that are performed to update a user profile in which subscriber usage data is kept.

FIG. 5 shows a series of steps performed in a preferred embodiment that are performed to track subscriber usage.

### DETAILED DESCRIPTION OF A PREFERRED EMBODIMENT

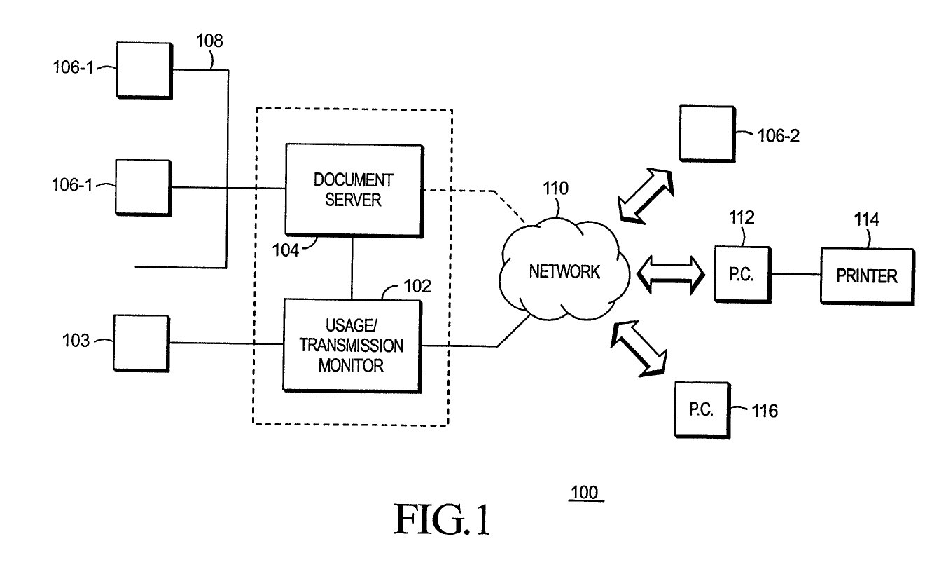

FIG. 1 shows a simplified depiction of an on-line publication system 100. A document server 104, which is typically one or more computers cooperatively linked together by data links (electronic communication pathways by which computer can exchange data) well known to those skilled in the art, collects data, information and content stories from other computers 106 whereat such files are located and available and to which the document server 104 is linked or coupled. In one embodiment, the document server 104 can be linked or coupled to computers 106-1 that provide content (e.g., stories, information, data, etc.) for publication (i.e. copying and distribution or simply distribution) via dedicated data links 108 between the content computers 106 and the document server 104. In a preferred embodiment, the document server 104 is operatively coupled to content computers (i.e., a computer or computers of a publication, such as the Chicago Tribune or Wall Street Journal, from which stories or other works of authorship can be obtained by electronic file transfers, one of which is shown as element 106-2) via a data network 110. In the preferred embodiment, the data network 110 is comprised of the Internet albeit other local or wide area networks would be equally feasible so long as such networks allow file transfers between the computers to which it is coupled.

The content computers 106 provide content information (also referred to herein as content data) in which text and images are formatted or encoded such that when the content data is displayed by a web browser or other program running on a subscriber's computer 112, 116, the content information or data yields recognizable images and text on a computer screen or printed page. As is known in the art, the Internet and web browsers allow data and files on one computer, such as the document server 104, to be downloaded to another computer such as one of the subscriber computers 112, and 116 using well-known protocols such as HTTP. For purposes of this disclosure, the text (and images, if any) of content data on the document server 104 (or the functional equivalent of the document server) as well as any other work of authorship, including video and audio, comprises a document. One or more documents comprise a “publication.” For purposes of claim construction therefore, electronic forms of documents such as letters and e-mail but also pictures, video and audio that is embodied as one or more data files, can be considered to be publications. Electronic forms of thematic magazines, books, journals are also considered to be publications, as are newspapers, examples of which include, but are not limited to magazines and publications like Time™, Newsweek™, US News and World Report™ the New York Times™ and Chicago Tribune™. For purposes of claim construction therefore, a publication is considered to be any work of authorship protected under Title 17 of United Stated Code, that can be transmitted electronically via a network after being appropriately digitized or converted into another transmissible signal. The document server 104 performs the function of collecting publications from a variety of electronic sources, either by soliciting the publications from the source computers 106 or receiving transmissions initiated by the source computers. The document server formats the publications and then initiates transmissions of the publications to the subscribers 112 and 116 or downloads the publications to the subscribers in response to subscriber requests. The protocol (e.g. HTTP) used to send and receive publication file transmissions is not germane to the invention disclosed herein.

In one embodiment, the document server 104 can communicate directly with source computers 106 via dedicated communication links, including those provided by the public switched telephone network (PSTN). In the preferred embodiment, the document server 104 communicates directly with other computers 106 via the Internet 110.

In at least one alternate embodiment, the document server 104 communicates through another computer denominated as a usage/transmission monitor 102, at least one function of which is to act as an agent or interface for the document server 104. In such an embodiment, requests for documents from the subscribers 112, 116 are sent to the usage transmission monitor 102, which then sends the requests to the document server 104. Outbound file transmissions (from the document server 104) to subscriber computers 112, 116 can also be passed from the document server 104 to the usage transmission monitor 102. The usage transmission monitor 102, (operatively coupled to a data network 110) routes transmissions to the subscribers 112, 116. Those skilled in the art will recognize that the functionality of both the document server 104 and the usage transmission monitor 102 can be readily accomplished using one computer and software that performs each of the respective functions, described and claimed herein, on a single machine as well as several distributed computers which each run software to perform the functions described and claimed herein. In the preferred embodiment, a single computer (shown by the broken lines circumscribing the document server and usage monitor) performs both functions using different software executing on the same computer.

At least one function of the usage transmission monitor 102 (or its software equivalent) is to track publication (distribution) of various publications from the document server 104 (or it's software equivalent) to various recipient subscriber computers 112, 116. As shown in FIG. 1, the usage transmission monitor 102 has access to at least one mass storage device 103 (magnetic tape, disk drives, etc.) whereat subscriber usage data is stored in a user profile by the usage transmission monitor 102. The user or subscriber profile is a data structure whereat subscriber usage data is organized so as to be retrievable and is a historical record of each subscriber's 112, 116 access to and usage of an on-line publication (a publication available from the document server via the data network 110). The usage data in a profile will include items such as a record of each time that a subscriber 112, 116 logs onto the document server 104; the files that the subscriber 112, 116 requests and whether the subscriber requested a download of particular files.

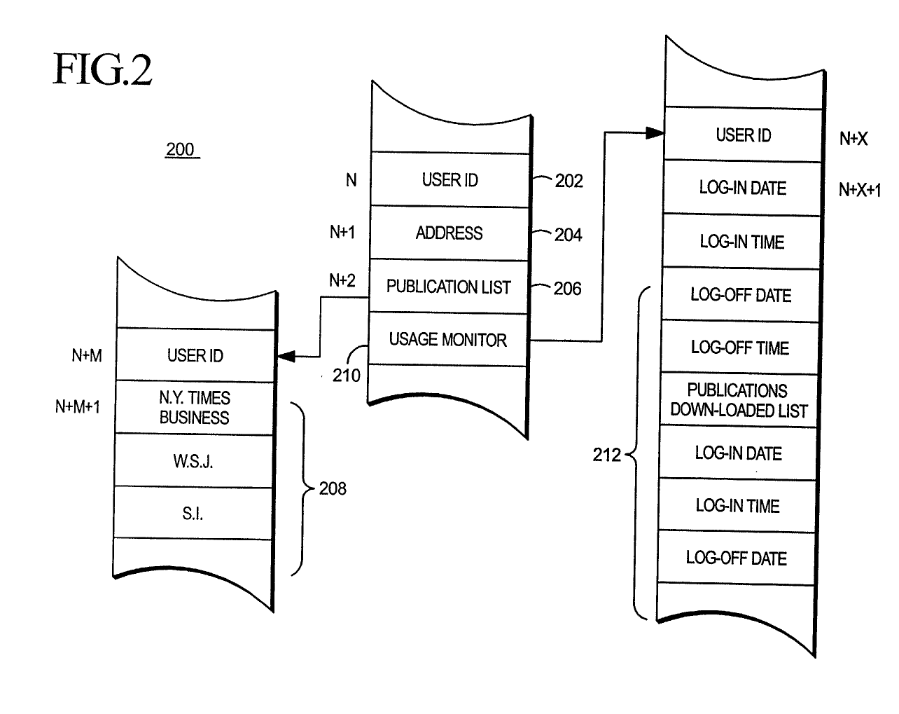

FIG. 2 shows a user profile 200 organized as a data structure that holds usage data of a subscriber's use of on-line publications. The data within the profile is physically held in memory devices such as random access memory (RAM), electrically erasable programmable read only memory (EEPROM) disk or tape storage and equivalents thereof. The use of magnetic tape, disk storage and RAM and EEPROM to store data is well known to those of ordinary skill in the art.

In FIG. 2, a user identifier or user ID 202 identifies a particular subscriber to whom the other data in the data structure corresponds. In addition to a user ID, the profile 200 can also include an electronic or physical address 204 whereat communications (and publications) to (or for) the subscriber can be sent. The user ID 202 and the subscriber address 204 are shown in FIG. 2 as two successive memory locations, however, those skilled in the art will recognize that the user ID and address might require several memory locations to store all of the data for these items.

A publication list location pointer 206 is a vector or starting memory address of an array whereat the list of publications to which the user has subscribed is stored. In other words, the data stored in the memory location identified as the publication list 206 simply points to another area of memory whereat the list of the subscriber's subscription publications are stored.

Memory array 208 shows an exemplary arrangement of a range of memory whereat the on line publications to which a subscriber has subscribed is stored in memory. The list of publications (that the subscriber has subscribed to) stored in memory array 208 include the N.Y. Times, the Wall Street Journal and Sports Illustrated. In a preferred embodiment, the contents of array 208 will include the electronic address whereat the publications can be obtained. In at least one alternate embodiment, the list of publications include video or audio programming available via the subscriber's Internet service provider and would include an electronic address whereat streaming audio or video can be downloaded.

The usage monitor field 210 is also a pointer to another memory array 212 whereat historical usage data is kept. In array 212, the log in dates and times and log out dates and times are stored in memory with a listing of each of the publications downloaded.

A subscriber's historical records of his or her access to, and usage of an on-line publication stored in a user profile 200, such as that depicted in FIG. 2, provides valuable data that can be used to enhance circulation of other publications and can be used to enhance the effectiveness of revenue-generating advertising that is distributed to subscribers via the on-line publishing system 100 and which generates revenue for the operators of the publishing system 100. In general, it is believed that a user who already receives many publications, or who spends considerable time downloading or reading one or more on-line publications already, is less likely to be receptive to more such publications. Such an individual might be better served and more receptive to advertising that is paid for to be placed in publications that the user already reads. Data in the user profile 200 is used by the methodology disclosed hereinafter to determine whether an advertisement for other on-line publications (referred to hereafter as “targeted content advertising”) should be sent to a subscriber or if instead, revenue generating “paid advertising” should be sent to a subscriber. The delivery of either form of advertising is preferably via a data network, however, other delivery mechanisms including the U.S. Postal Service can also be used to deliver advertising to on-line subscribers as well.

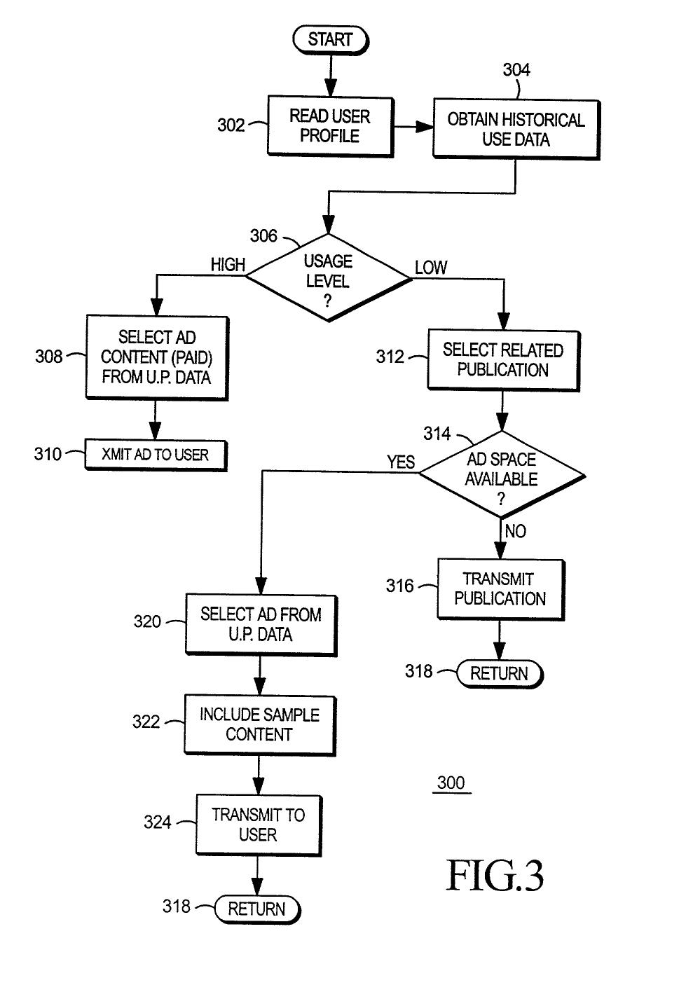

FIG. 3 shows a flow chart 300 of steps performed to determine the kinds of advertising which should be delivered to an on-line subscriber in order to increase circulation of other publications or increase revenue.

In FIG. 3, a user profile 200 is read from memory in step 302, preferably by either the document server 104 or the usage monitor 102. Using data from the user profile 200, historical data on the subscriber's access to various on-line publications is obtained in step 304.

In step 306, if it's determined from the historical usage level data that the subscriber is a “high” frequency user, i.e. frequently accesses and downloads one or more publications, a decision is made in step 306 to not bother trying to sell more on-line publications to such a user but instead to send the user paid advertising in step 308.

In step 308, an advertising message can be selected for the subscriber by using data in the user profile. By way of example, if the subscribe frequently downloads publications related to fishing and hunting, advertising of hunting and fishing equipment manufacturers can be specifically targeted to the subscriber, formatted for delivery and transmitted to the subscriber in step 310.

Referring back to step 306, if it is determined that the subscriber is a “low” frequency user, as determined by the number of publications sent to the subscriber and the number of times the publication(s) were sent, from empirical data it can be said that such a user might be receptive to other, related publications, and, in step 312, a list of publications related to any one or more that the subscriber already receives can be identified and promoted to the subscriber by sending him or her an advertisement promoting the publication.

In step 314, a determination is made as to whether any time or space is available in an existing subscription whereat an advertisement for a related publication can be inserted. If space and/or time are available, in step 320, using data in the profile, an advertisement for related publications is selected, formatted and in steps 322 and 324, included in the existing subscribed-to publication and sent to the subscriber. If no space or time to include a related publication ad is available, in step 314 a decision is made to simply send the subscribed to publication in step 316 and forego additional advertising for the sake of subscriber satisfaction. In step 318, program control returns to the program that called the advertisement selection routine 300.

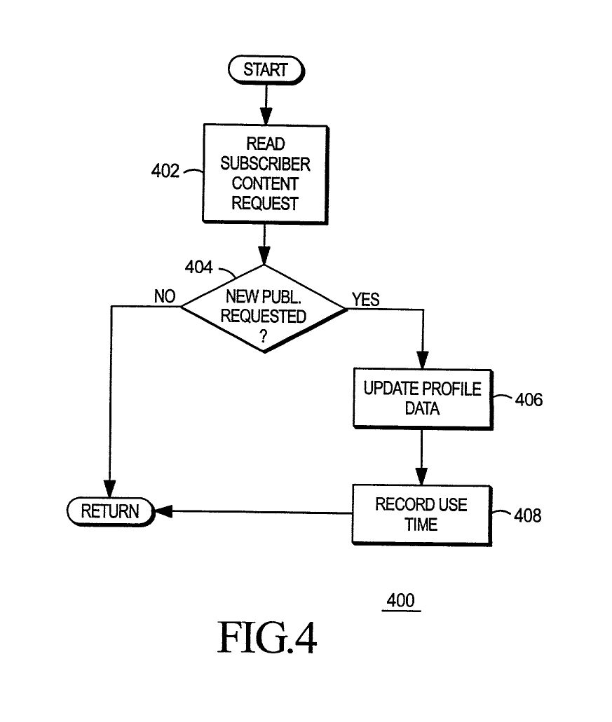

In FIG. 4, a flow chart of new subscription detection and use 400 includes a detection of a new publication request in step 402. Detecting when an on-line subscriber 112, 116 might request a new publication can be made by filtering upstream messages to the document server 104 or usage monitor 102 and reading requests sent to particular addresses. In step 404, if a new publication is requested, in step 406 the user profile 200 is updated and usage data collected for subsequent analysis in step 408.

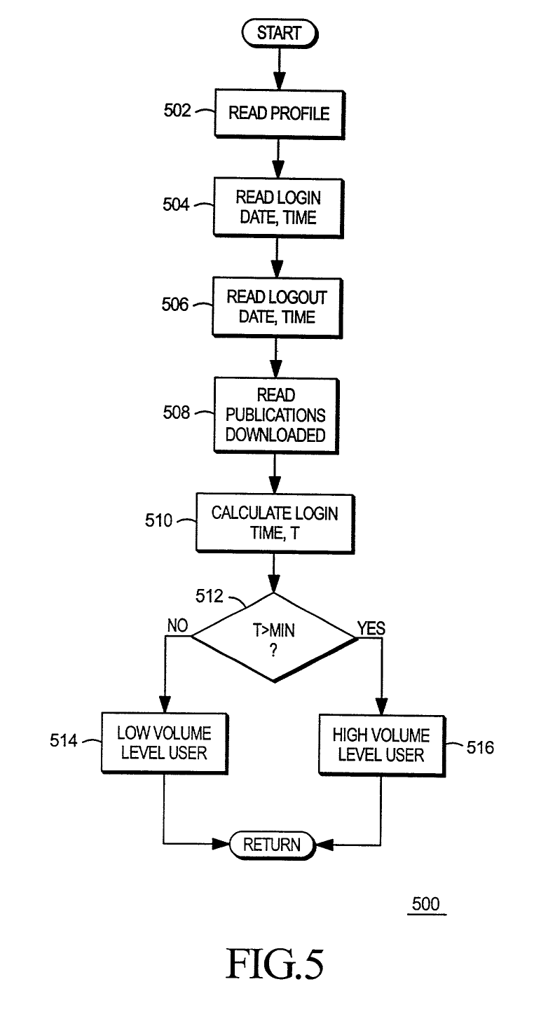

FIG. 5 shows a simplified methodology 500 by which a subscriber can be determined to be a high or low frequency user.

In step 502, data from the user profile 200 is read and, in steps 504 and 506, from that data, the dates and times of access to a publication, among other things, is determined. In step 508, the identity of publications read or obtained is also determined and in step 510, the time that the subscriber spent or the publications he requested is determined. In step 512, the amount of time that the subscriber accessed a publication, or the number of publications he obtained or read is quantified and if it is determined that his use or subscription rate is above an empirically determined minimum threshold, the subscriber is identified as a high frequency or low frequency user.

The thresholds that determine if a user is high frequency or low frequency user (and thereafter targeted to receive ads for either different publications or ads for products or services) will be subjective from person to person and therefore an inexact determination. A certain amount of experimentation might therefore be required to determine whether certain types of subscribers are more receptive to ads for related publications or are more receptive to product advertising. Regardless of how the threshold for user characterization is determined, the categorization of an on-line publication user can be used as a reasonable predictor of whether the subscriber should be sent ads for more or different publications or product or service ads placed in an on-line publication to which the person is already a subscriber.

By tracking usage and access of an on-line publication by a subscriber, it is possible to target ads for other publications to subscribers likely to be receptive to receipt of other publications. Accordingly, it is possible to increase circulation of publications by targeting ads more carefully. As an adjunct to such advertising, it is effective to send the prospective customer or subscriber a sample of the publication, which is performed in step 322 shown in FIG. 3.

What is claimed is:

1. In an on-line publication (“publication”) distributed to a plurality of publication subscribers via a data network, a method of sending to a publication subscriber, at least one of either: paid advertising messages or content advertising messages;
said method comprising the steps of:
reading from a server, a user profile for said subscriber;
determining the subscriber's publication usage levels from data in said user profile;
if the subscriber's usage level is determined to be above a first predetermined level (“high”) sending the subscriber a targeted paid advertisement;
if the subscriber's usage level is determined to be below a second predetermined threshold, (“low”) sending the subscriber a targeted content advertisement for the publication in which said targeted content advertisement is placed.

2. The method of claim 1 wherein said step of sending a targeted content advertisement is further comprised of the step of:
selecting a content advertisement for transmission to the user, the selection of which is based upon at least one of:
data in said user profile; and
advertising space available in said publication for content advertising usage.

3. The method of claim 1 wherein said step of sending a targeted content advertisement is further comprised of the step of:
selecting a content advertisement for transmission to the user, the selection of which is based upon at least one of:
data in said user profile; and
advertising space available in said publication for content advertising usage; and
including in said content advertisement, a sample of the specified content and instructions as to how to continue to receive said specified content via said publication.

4. The method of claim 1 wherein said step of sending a targeted content advertisement is further comprised of the step of:
selecting a content advertisement for transmission to the user based upon said user profile and the advertising space available for content advertising usage;
including in said content advertisement a sample of the specified content and instructions as to how to receive said content;
assembling said content advertisement and said sample of the specified content into a data package and transmitting the data package to the subscriber via said data network.

5. The method of claim 1 further comprised of the steps of:
detecting via said data network, the subscriber's request for continued delivery of said specified content via said data network;
modifying data in the user profile to reflect the subscriber's request for continued delivery of said specified content.

6. The method of claim 1 further comprised of the steps of:
detecting via said data network, the subscriber's request for continued delivery of said specified content via said data network;
modifying data in the user profile to reflect the subscriber's request for continued delivery of said specified content;
monitoring the subscriber's usage levels of said publication.

7. In an on-line publication (“publication”) distributed to a plurality of publication subscribers via a data network, a method of sending to a publication subscriber, at least one of either: paid advertising messages or content advertising messages;
said method comprising the steps of:
reading from a server for said publication, a user profile for the subscriber;
determining the subscriber's publication usage levels from data in said user profile;
if the subscriber's usage level is above a first predetermined level (“high”) sending the subscriber a targeted paid advertisement;
if the subscriber's usage level is below a second predetermined threshold, (“low”) sending the subscriber a targeted content advertisement for the publication, said targeted content advertisement being selected based upon at least one of:
data in said user profile; and
advertising space available in said publication for content advertising usage; and
including in said content advertisement a sample of the specified content and instructions as to how to receive said content.

8. In an on-line publication (“publication”) distributed to a plurality of publication subscribers via a data network, a method of sending to a publication subscriber, at least one of either: paid advertising messages or content advertising messages;
said method comprising the steps of:
reading from a server for said publication, a user profile for the subscriber;
determining the subscriber's publication usage levels from data in said user profile;
if the subscriber's usage level is above a first predetermined level (“high”) sending the subscriber a targeted paid advertisement;
if the subscriber's usage level is below a second predetermined threshold, (“low”) sending the subscriber a targeted content advertisement for the publication, said targeted content advertisement being selected based upon at least one of:
data in said user profile; and
advertising space available in said publication for content advertising usage; and
including in said content advertisement a sample of the specified content and instructions as to how to receive said content;
detecting the subscriber's request for continued delivery of said specified content via said data network;
modifying data in the user profile to reflect the subscriber's request for continued delivery of said specified content.

9. In an on-line publication (“publication”) distributed to a plurality of publication subscribers via a data network, a method of sending to a publication subscriber, at least one of either: paid advertising messages or content advertising messages;
said method comprising the steps of:
reading from a server for said publication, a user profile for the subscriber;
determining the subscriber's publication preferences from data in said user profile;
if the subscriber's usage level is above a first predetermined level, (“high”) sending the subscriber a targeted paid advertisement consistent with the subscriber's determined preferences;
if the subscriber's usage level is below a second predetermined threshold, (“low”) sending the subscriber a targeted content advertisement consistent with the subscriber's determined preferences.

10. The method of claim 9 wherein said step of sending a targeted content advertisement is further comprised of the step of:
selecting a content advertisement for transmission to the user, the selection of which is based upon at least one of:
data in said user profile; and
advertising space available in said publication for content advertising usage.

11. The method of claim 9 wherein said step of sending a targeted content advertisement is further comprised of the step of:
selecting a content advertisement for transmission to the user, the selection of which is based upon at least one of:
data in said user profile; and
advertising space available in said publication for content advertising usage; and
including in said content advertisement a sample of the specified content and instructions as to how to receive said content.

12. The method of claim 9 wherein said step of sending a targeted content advertisement is comprised of the step of:
selecting a content advertisement for transmission to the user based upon at least one of:
data in said user profile; and
advertising space available for content advertising usage; and.
including in said content advertisement a sample of the specified content and instructions as to how to receive said content;
assembling said content advertisement and said sample of the specified content into a data package and transmitting the data package to the subscriber.

13. The method of claim 9 further comprised of the steps of:
detecting the subscriber's request for continued delivery of said specified content;
modifying data in the user profile to reflect the subscriber's request for continued delivery of said specified content.

14. The method of claim 9 further comprised of the steps of:
detecting the subscriber's request for continued delivery of said specified content;
modifying data in the user profile to reflect the subscriber's request for continued delivery of said specified content;
monitoring the subscriber's usage levels.

15. In an on-line publication system which distributes an on-line publication to a plurality of subscribers via a data network an apparatus for distributing to a subscriber, at least one of either: a paid advertising message or a content advertising message, said apparatus comprised of:
a first computer coupled to said data network and having access to a user profile for a subscriber;
a second computer coupled to said data network and for determining the subscriber's publication usage level from data in said user profile and for:
transmitting to said subscriber, a targeted paid advertisement consistent with the subscriber's determined preferences if the subscriber's usage level is above a first predetermined level (“high”);
transmitting to said subscriber, a targeted content advertisement consistent with the subscriber's determined preferences if the subscriber's usage level is below a second predetermined threshold, (“low”).

16. In an on-line publication system, which distributes an on-line publication to a plurality of subscribers via a data network, an apparatus for distributing to a subscriber, at least one of either: a paid advertising message or a content advertising message,
said apparatus comprised of:
a computer means for:
accessing a user profile for a subscriber;
determining from data in the user profile, the subscriber's publication preferences, and for:
transmitting to said subscriber, a targeted paid advertisement consistent with the subscriber's determined publication preferences if the subscriber's usage level is above a first predetermined level (“high”);
transmitting to said subscriber, a targeted content advertisement consistent with the subscriber's determined publication preferences if the subscriber's usage level is below a second predetermined threshold, (“low”).
